(19) United States
(12) Patent Application Publication
(10) Pub. No.: US 2022/0408699 A1
(43) Pub. Date: Dec. 29, 2022

(54) HUMMINGBIRD FEEDER

(71) Applicant: Craig Stroia, Wyandotte, MI (US)

(72) Inventor: Craig Stroia, Wyandotte, MI (US)

(21) Appl. No.: 17/840,294

(22) Filed: Jun. 14, 2022

Related U.S. Application Data
(60) Provisional application No. 63/214,779, filed on Jun. 24, 2021.

(51) Int. Cl. A01K 39/02; A01K 39/01

(52) U.S. Cl. CPC A01K 39/0206; A01K 39/01

(57) ABSTRACT

A hummingbird feeder for feeding hummingbirds which can utilize recyclable containers and bottles. The hummingbird feeder can include a reservoir that has a cavity and a flange along a periphery of the cavity and a feed plate is coupled to the reservoir. The feed plate has a central hole. An adapter that has a bottom portion and a top portion, the bottom portion is sealably coupled to the central hole of the feed plate and the top portion can sealably fit into a mouth of a container. The sleeve has a broad open top and a narrow bottom opening, wherein the bottom opening is configured to receive the top portion of the adapter, the sleeve configured to encase the container.

### CROSS-REFERENCE TO RELATED APPLICATIONS

This application claims priority from a U.S. Provisional Patent Appl. No. 63/214,779 filed on Jun. 24, 2021, which is incorporated herein by reference in its entirety.

### FIELD OF INVENTION

The present invention relates to bird feeders, and more particularly, the present invention relates to a hummingbird feeder and a method of use thereof.

### BACKGROUND

Many people like to feed birds. Typically, a feeder cup is used to feed the birds. The feeder cup is simple to use and economical, however, the feeder cup attracts a lot of contaminants, such as insects and bees. Closed bird feeders are also known in the art; however, the known closed bird feeders are costly and complex in use.

Thus, a need is appreciated for a novel bird feeder that is devoid of the drawbacks of known bird feeders.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a bird feeder that utilizes a reusable reservoir.

It is another object of the present invention that the bird feeder is economical to manufacture.

It is still another object of the present invention that a reusable reservoir or bottle can be used.

It is yet another object of the present invention to protect the birds' feed from UV rays.

It is a further object of the present invention that the level of bird feed in the reservoir can be easily checked.

A hummingbird feeder comprises:
a reservoir that has a cavity and a flange along a periphery of the cavity;
a feed plate is configured to couple to the reservoir, wherein the feed plate and the cavity form an enclosed volume, the feed plate has a central hole;
an adapter that has a bottom portion and a top portion, the bottom portion is configured to sealably couple to the central hole of the feed plate, the top portion of the adapter is configured to sealably fit into a mouth of a container; and
a sleeve that has a broad open top and a narrow bottom opening, wherein the bottom opening is configured to receive the top portion of the adapter, the sleeve configured to encase the container.

The hummingbird feeder according to claim 1, wherein the sleeve further comprises a pair of flaps that extend from a periphery of the open top, each flap of the pair of flaps has an aperture for a hook to pass through.

The hummingbird feeder according to claim 1, wherein the sleeve is made from an opaque material.

The hummingbird feeder according to claim 1, wherein the sleeve is made from neoprene.

The hummingbird feeder according to claim 1, wherein the sleeve is made of thermally insulating material.

The hummingbird feeder according to claim 1, wherein the feed plate comprises one or more feed apertures around the central hole.

The hummingbird feeder according to claim 1, wherein the feed plate and the flange of the reservoir comprises mating members for coupling the feed plate to the reservoir.

The hummingbird feeder according to claim 1, wherein the top portion of the adapter has spaced apart ridges on its outer surface for sealably fitting into the mouth of the container.

The hummingbird according to claim 1, wherein the container is a bottle that has a neck and a mouth.

A method for feeding hummingbirds, the method comprises the steps of:
providing a hummingbird feeder comprises:
   a reservoir that has a cavity and a flange along a periphery of the cavity;
   a feed plate is configured to couple to the reservoir, wherein the feed plate and the cavity form an enclosed volume, the feed plate has a central hole;
   an adapter that has a bottom portion and a top portion, the bottom portion is configured to sealably couple to the central hole of the feed plate, the top portion of the adapter is configured to sealably fit into a mouth of a container; and
a sleeve that has a broad open top and a narrow bottom opening, wherein the bottom opening is configured to receive the top portion of the adapter, the sleeve configured to encase the container.

The method according to claim 10, wherein the sleeve further comprises a pair of flaps that extend from a periphery of the open top, each flap of the pair of flaps has an aperture for a hook to pass through.

The method according to claim 10, wherein the sleeve is made from an opaque material.

The method according to claim 10, wherein the sleeve is made from neoprene.

The method according to claim 10, wherein the sleeve is made of thermally insulating material.

The method according to claim 10, wherein the feed plate comprises one or more feed apertures around the central hole.

The method according to claim 10, wherein the feed plate and the flange of the reservoir comprises mating members for coupling the feed plate to the reservoir.

The method according to claim 10, wherein the top portion of the adapter has spaced apart ridges on its outer surface for sealably fitting into the mouth of the container.

The method according to claim 10, wherein the container is a bottle that has a neck and a mouth.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a perspective view of a bird feeder, according to an exemplary embodiment of the present invention.

FIG. 2 shows the sleeve of the bird feeder, according to an exemplary embodiment of the present invention.

FIG. 3A shows a top view of the reservoir, according to an exemplary embodiment of the present invention.

FIG. 3B shows a side view of the reservoir, according to an exemplary embodiment of the present invention.

FIG. 4A shows a top view of the feed plate, according to an exemplary embodiment of the present invention.

FIG. 4B is a perspective view of the feed plate, according to an exemplary embodiment of the present invention.

FIG. 5 shows an adapter, according to an exemplary embodiment of the present invention.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as apparatus and methods of use thereof. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

The following detailed description is described with reference to the drawings, wherein like reference numerals are used to refer to like elements throughout. In the following description, for purposes of explanation, specific details may be set forth to provide a thorough understanding of the subject innovation. It may be evident, however, that the claimed subject matter may be practiced without these specific details. In other instances, well-known structures and apparatus are shown in block diagram form to facilitate describing the subject innovation. Moreover, the drawings may not be to scale.

Disclosed is a hummingbird feeder that provides for feeding hummingbirds with nectar or any liquid food. The disclosed hummingbird feeder can receive any suitable container, such as plastic water bottles and wine bottles. The container can be interchangeably used, wherein an adapter of the disclosed hummingbird feeder provides compatibility for a wide variety of containers. The disclosed hummingbird feeder can prevent the feed from contaminants and direct sunlight. Ultraviolet rays can accelerate the degradation of certain ingredients of the feed, and the disclosed hummingbird feeder can prevent exposure of the feed from direct sunlight while also allowing checking levels of the feed without disassembling the hummingbird feeder. The hummingbird feeder can easily be hung using a hook to a variety of support structures.

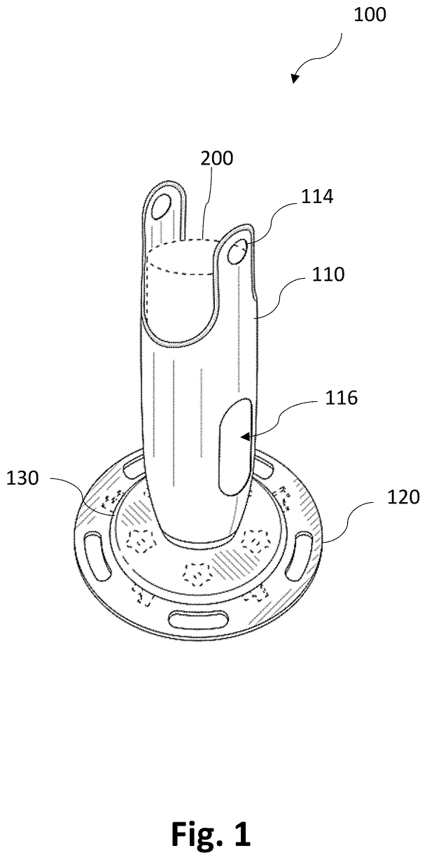

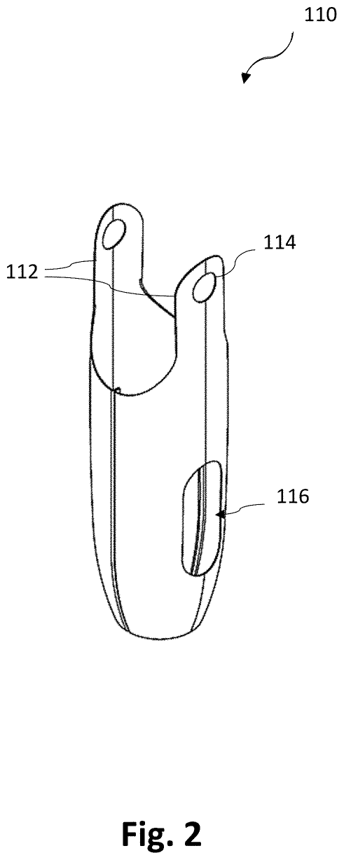

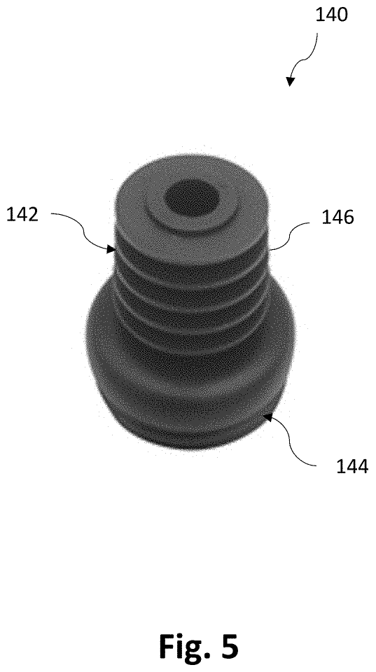

Referring to FIG. 1 is a perspective view of the disclosed hummingbird feeder 100. The hummingbird feeder 100 can include a sleeve 110, a reservoir 120, a feed plate 130, and an adapter 140 (shown in FIG. 5). An embodiment of the sleeve 110 is shown in FIG. 2 which is substantially cylindrical to house cylindrical shape containers, such as bottles. FIG. 1 shows a bottle 200 within the sleeve 110 in an inverted position. While the embodiments describe the container as a cylindrical bottle, however, a polygonal shape container is within the scope of the present invention. Moreover, the containers of different sizes are within the scope of the present invention. Preferably, a container with a neck and a mouth can be used with the disclosed hummingbird feeder 100. The sleeve can include an open-top through which a container can be inserted. The bottom of the sleeve narrows down and forms an opening so that the sleeve can support the neck of the container, while the mouth of the container can protrude from the bottom opening. The open top is broader than the opening at the bottom. Two flaps 112 extend from the top periphery of the sleeve, wherein each of the two flaps can have an aperture 114. A hook can pass through the two apertures in the flaps for mounting the disclosed hummingbird feeder to a supporting structure. Each of the two apertures can have a lining of durable material, such as metal to prevent damage to the sleeve.

The sleeve 110 can further include an elongated window 116 near the bottom of the sleeve. The elongated window provides a view of the container 200 so that a user can check the level of the feed in the container 200. The feed can be any liquid food for the hummingbirds, such as sweet nectar.

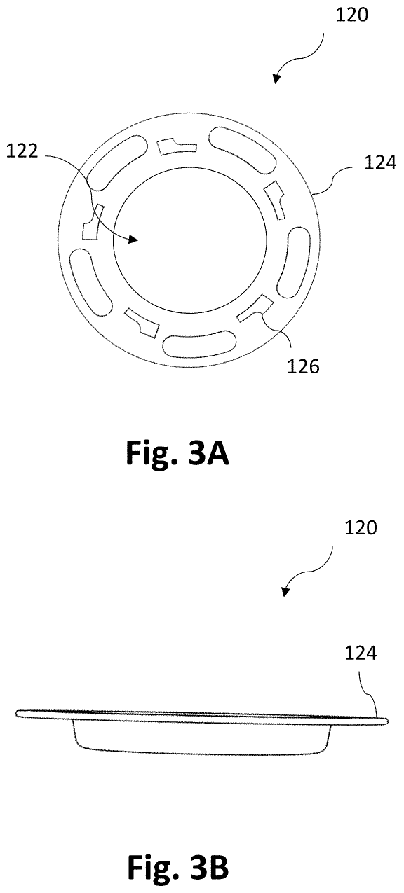

Referring to FIGS. 3A and 3B show top and side views of the reservoir 120. The reservoir can include a cavity 122 in which a small amount of the feed from the container can be held. A flange 124 surrounds the cavity, wherein the flange has a groove 126 for the twist-lock fastening mechanism.

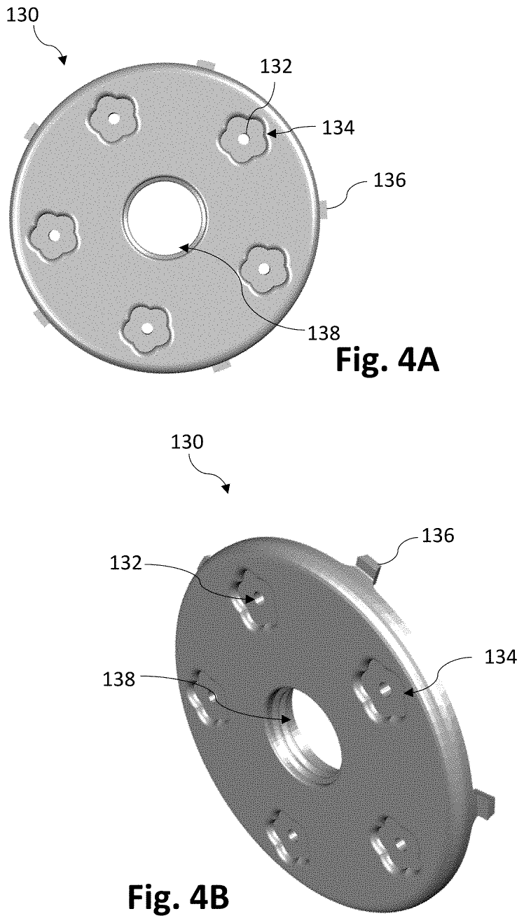

Referring to FIGS. 4A and 4B show a feed plate 130. The feed plate 130 can cover the reservoir sealably so that a vacuum can be created within the reservoir. The feed plate can include one or more feed apertures 132 through which the hummingbirds can feed. Around the feed apertures can be a design 134 resembling a flower that can attract the birds. The bottom periphery of the feed plate can include spaced-apart protrusions 136 that can fasten to the respective grooves 126 in the reservoir flange 124. For example, the protrusions can twist lock with the grooves in the flange of the reservoir. The feed plate can include a central hole 138 to which an adapter can be coupled.

FIG. 5 shows the adapter 140 that has an upper portion 142 and a bottom portion 144. The bottom portion of the adapter can sealably and removably coupled to the central hole 138 in the feed plate 130. The upper portion 142 of the adapter 140 can fit into a mouth of the container. The outer surface of the upper portion has ridges 146 that allow a sealable connection between the adapter and the container.

In use, the feed plate can be coupled to the reservoir using the twist-lock mechanism, it is understood, however, any other fastening mechanism for coupling the feed plate to the reservoir is within the scope of the present invention. The adapter can be sealably coupled to the central hole of the feed plate. The sleeve can be donned over the container, the container in an upright position and contains the liquid feed so that the mouth of the container can protrude from the bottom opening of the sleeve. Thereafter, the adapter can be sealably coupled to the mouth of the bottle. The hummingbird feeder with the bottle then can be inverted and hung using a hook.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A hummingbird feeder comprises:
a reservoir that has a cavity and a flange along a periphery of the cavity;
a feed plate is configured to couple to the reservoir, wherein the feed plate and the cavity form an enclosed volume, the feed plate has a central hole;
an adapter that has a bottom portion and a top portion, the bottom portion is configured to sealably couple to the central hole of the feed plate, the top portion of the adapter is configured to sealably fit into a mouth of a container; and
a sleeve that has a broad open top and a narrow bottom opening, wherein the bottom opening is configured to receive the top portion of the adapter, the sleeve configured to encase the container.

2. The hummingbird feeder according to claim 1, wherein the sleeve further comprises a pair of flaps that extend from a periphery of the open top, each flap of the pair of flaps has an aperture for a hook to pass through.

3. The hummingbird feeder according to claim 1, wherein the sleeve is made from an opaque material.

4. The hummingbird feeder according to claim 1, wherein the sleeve is made from neoprene.

5. The hummingbird feeder according to claim 1, wherein the sleeve is made of thermally insulating material.

6. The hummingbird feeder according to claim 1, wherein the feed plate comprises one or more feed apertures around the central hole.

7. The hummingbird feeder according to claim 1, wherein the feed plate and the flange of the reservoir comprises mating members for coupling the feed plate to the reservoir.

8. The hummingbird feeder according to claim 1, wherein the top portion of the adapter has spaced apart ridges on its outer surface for sealably fitting into the mouth of the container.

9. The hummingbird feeder according to claim 1, wherein the container is a bottle that has a neck and a mouth.

10. A method for feeding hummingbirds, the method comprises:
providing a hummingbird feeder comprises:
a reservoir that has a cavity and a flange along a periphery of the cavity;
a feed plate is configured to couple to the reservoir, wherein the feed plate and the cavity form an enclosed volume, the feed plate has a central hole;
an adapter that has a bottom portion and a top portion, the bottom portion is configured to sealably couple to the central hole of the feed plate, the top portion of the adapter is configured to sealably fit into a mouth of a container; and
a sleeve that has a broad open top and a narrow bottom opening, wherein the bottom opening is configured to receive the top portion of the adapter, the sleeve configured to encase the container.

11. The method according to claim 10, wherein the sleeve further comprises a pair of flaps that extend from a periphery of the open top, each flap of the pair of flaps has an aperture for a hook to pass through.

12. The method according to claim 10, wherein the sleeve is made from an opaque material.

13. The method according to claim 10, wherein the sleeve is made from neoprene.

14. The method according to claim 10, wherein the sleeve is made of thermally insulating material.

15. The method according to claim 10, wherein the feed plate comprises one or more feed apertures around the central hole.

16. The method according to claim 10, wherein the feed plate and the flange of the reservoir comprises mating members for coupling the feed plate to the reservoir.

17. The method according to claim 10, wherein the top portion of the adapter has spaced apart ridges on its outer surface for sealably fitting into the mouth of the container.

18. The method according to claim 10, wherein the container is a bottle that has a neck and a mouth.
